(19) United States
(12) Patent Application Publication
(10) Pub. No.: US 2014/0210826 A1
(43) Pub. Date: Jul. 31, 2014

(54) ICON GENERATING SYSTEM AND STORAGE MEDIUM WITH ICON GENERATING FUNCTION AND ICON GENERATING METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHENG-CHIN CHIANG, New Taipei (TW); YAN LI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/147,623

(22) Filed: Jan. 6, 2014

(30) Foreign Application Priority Data
Jan. 31, 2013 (CN) 201310037923X

(51) Int. Cl. G06T 11/20

(52) U.S. Cl. CPC G06T 11/206
USPC 345/440

(57) ABSTRACT

An icon generating system applied to an electronic device capable of generating a step icon for representing a step of a manufacturing process is provided. The electronic device includes at least one hardware processor. The icon generating system includes a plurality of modules, the icon generating system comprising a plurality of modules executed by the at least one hardware processor, the modules comprise an instruction generating module for generating a description instruction in response to manual operation, a capturing module for capturing a scene graph of a step of the manufacturing process in response to the description instruction, and an icon processing module for generating a step icon according to the scene graph, and adds a step attribute with the step icon for associating the step icon with the step.

### BACKGROUND

1. Technical Field

The present disclosure relates to icon generating systems and methods, and particularly to a system and method for generating a step icon for representing a step of a manufacturing process.

2. Description of Related Art

A manufacturing process can be displayed in a process interface for showing all steps. In general, the steps can be represented by a predetermined icon. However, when a new step is needed to be described, the size of the predetermined icon may be too small to be seen, or the predetermined icon is not suitable for representing the new step.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of the icon generating system.

FIG. 2 illustrates an embodiment of a first status of a process interface utilized in the icon generating system.

FIG. 3 illustrates an embodiment of a scene graph and a scene icon corresponding to the scene graph utilized in the icon generating system.

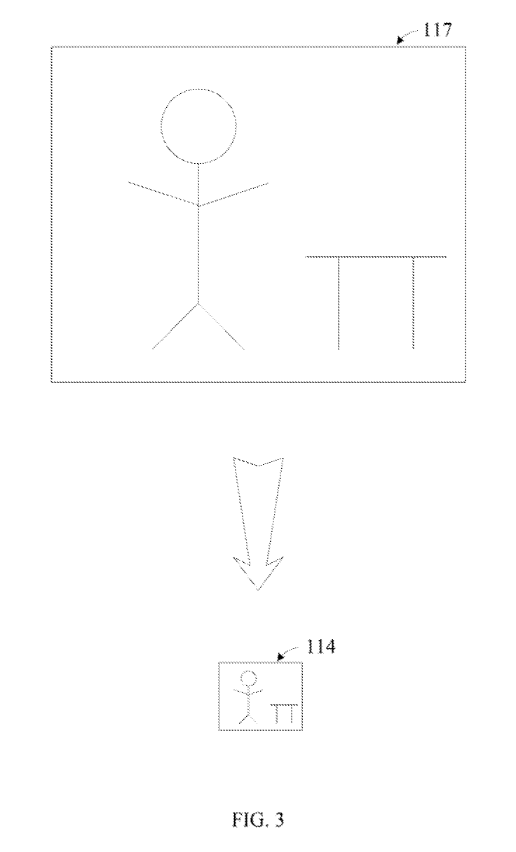

FIG. 4 illustrates an embodiment of a second status of the process interface utilized in the icon generating system.

FIG. 5 is a flow chart of an icon generating method implemented by the icon generating system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

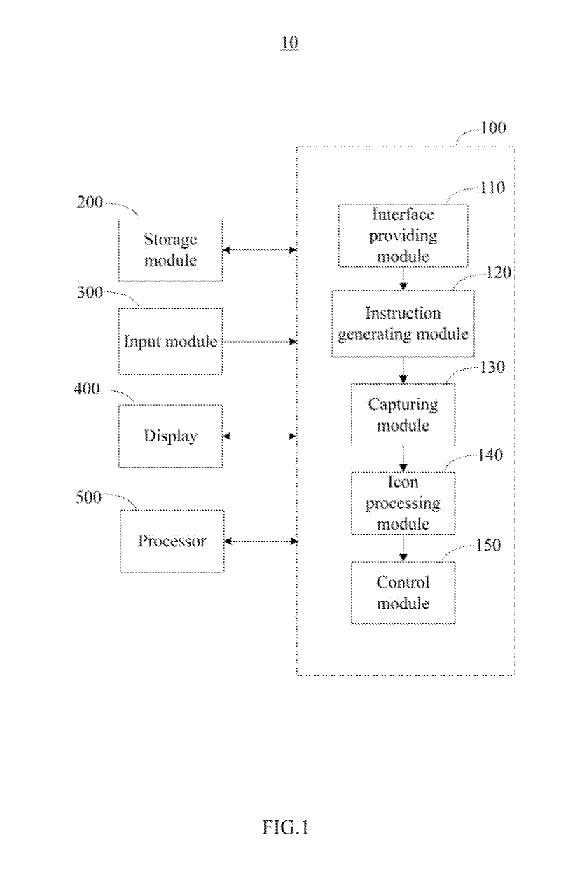

FIG. 1 is an icon generating system 100 applied to an electronic device 10. The electronic device 10 can be a desktop computer, a laptop, a tablet PC, a mobile phone, or the like. The electronic device 10 includes a storage module 200, an input module 300, a display 400, and at least one processor 500. The icon generating system 100 is stored in the storage module 200, and is executed by the processor 500 to generate a step icon for representing a step of a manufacturing process. The icon generating system 100 defines a step attribute of each step for associating the step with the step icon. In this embodiment, the process includes a number of sub-processes. Each sub-processes includes a preparative process, a processing process, a examination process, a storing process, a transporting process, a feeding process and a unloading process.

The icon generating system 100 includes an interface providing module 110, an instruction generating module 120, a capturing module 130, an icon processing module 140 and a control module 150. The processer executes the number of modules of the icon generating system 100 to perform functions of the electronic device 10.

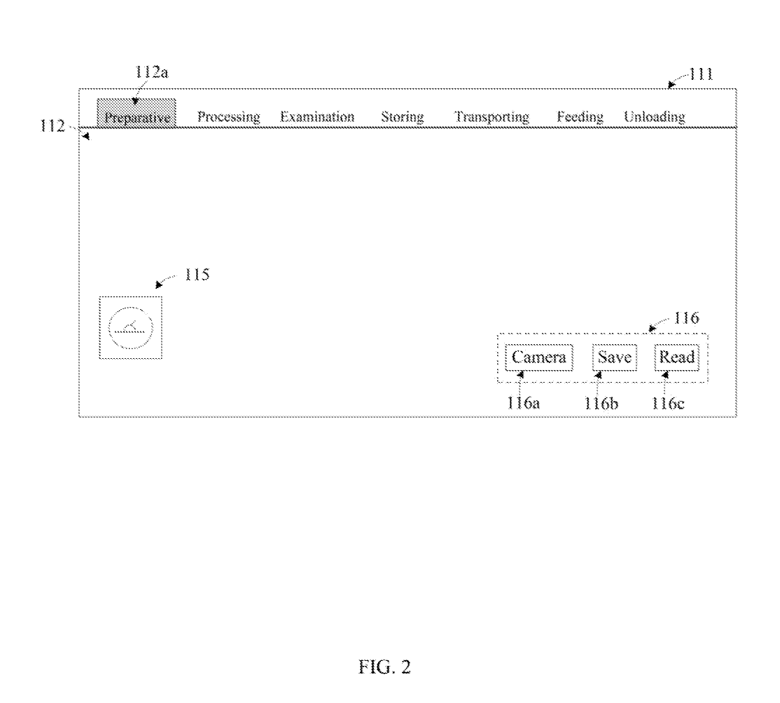

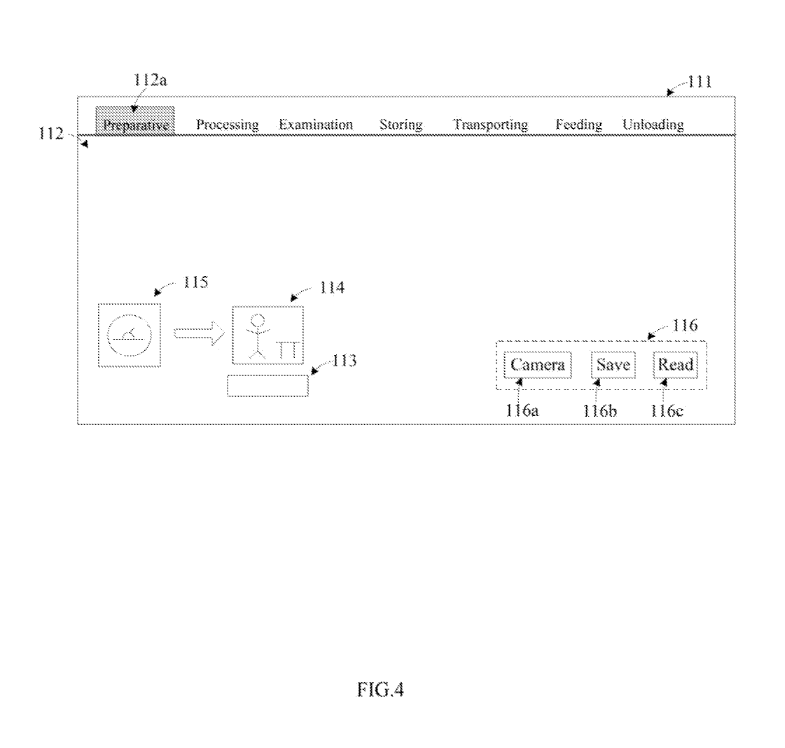

The interface providing module 110 controls the display 400 to display a process interface for showing the manufacturing process. FIG. 2 shows that the process interface 111 includes a number of sub-interfaces 112 corresponding to the sub-processes. Each sub-interface 112 includes a tag 112a for representing the corresponding sub-process. Accordingly, the process interface 111 includes a preparative interface, a processing interface, an examination interface, a storing interface, a transporting interface, a feeding interface and a unloading interface. FIG. 4 shows that each sub-interface 112 further includes an information frame 113 and a number of buttons 116. The information frame 113 displays detailed information of the step and can be edited by the user. In this embodiment, the buttons 116 includes a camera button 116a, a save button 116b, and a read button 116c. In other embodiments, the buttons 116 can be some specific keys of the input module 300.

The instruction generating module 120 generates a description instruction in response to manual operation. In this embodiment, when the user clicks the camera button 116a, the instruction generating module 120 generates a description instruction. When the user clicks the save button 116b, the instruction generating module 120 generates a save instruction. When the user clicks the read button 116c, the instruction generating module 120 generates a read instruction.

The capturing module 130 captures a scene graph of one step of the manufacturing process in response to the description instruction. For example, the capturing module 130 captures a scene graph 117 of the preparative process.

The icon processing module 140 generates a step icon according to the scene graph, and adds a step attribute with the step icon for associating the step icon with the step. In this embodiment, the icon processing module 140 reduces the size of the scene graph 117 to generate the step icon 114, and adds a preparative attribute with the step icon for associating the step icon with the preparative process. When the user clicks the save button 116b, the icon processing module 140 stores the step icon 114 and the scene graph 117 to the storage module 200.

The icon processing module 140 further associates the step icon 114 with the scene graph 117, and stores the scene graph 117 in the storage module 200.

FIG. 4 shows that the control module 150 controls the display 400 to display the step icon in the process interface according to the step attribute of the step icon. In this embodiment, the control module 150 controls the display 400 to display the step icon 114 in the preparative interface according to the preparative attribute. In other embodiment, the control module 150 obtains the step icon 114 from the storage module 200 when the user clicks the read icon 116c, and controls the display 400 to display the step icon 114 in the current sub-interface. Thus, when two processes include the same step, the icon generating system 100 does not need to capture the scene graph again.

The control module 150 further controls the display 400 to display the scene graph 117 in response to the manual operation, for showing the process scene more clearly. In this embodiment, when the user double clicks the step icon 114, the scene graph 117 can be floated on the process interface.

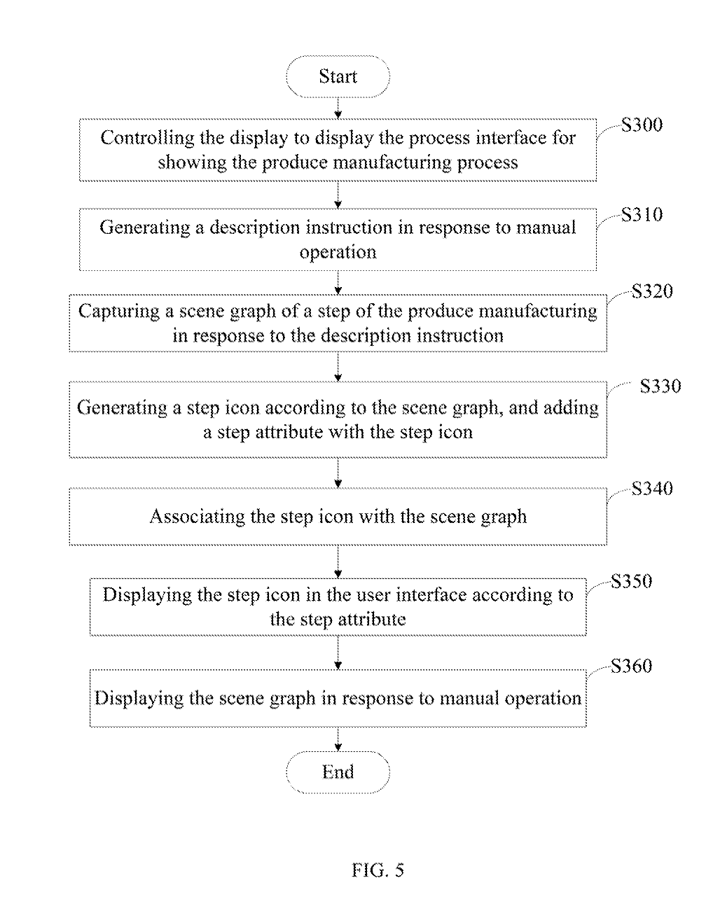

FIG. 5 shows a flowchart of an icon generating method. The method is implemented by the icon generating system 100 applied to an electronic device 10. The method comprises the following steps:

In step S300, the interface providing module 110 controls the display 400 to display a process interface for showing a manufacturing process.

In step S310, the instruction generating module 120 generates a description instruction in response to manual operation.

In step S320, the capturing module 130 captures a scene graph of a step of the manufacturing process in response to the description instruction.

In step S330, the icon process module 140 generates a step icon according to the scene graph, and adds a step attribute with the step icon for associating the step icon with the step. In this embodiment, the icon processing module 140 reduces the size of the scene graph 117 to generate the step icon 114, and adds a preparative attribute with the step icon for associating the step icon with the preparative process.

In step S340, the icon process module 140 associates the step icon 114 with the scene graph 117, and stores the scene graph 117 in the storage module 200.

In step S350, the control module 150 controls the display 400 to display the step icon in the process interface according to the step attribute of the step icon. In this embodiment, the control module 150 controls the display 400 to display the step icon 114 in the preparative interface according to the preparative attribute. In other embodiment, the control module 150 obtains the step icon 114 from the storage module 200 when the user clicks the read icon 116c, and controls the display 400 to display the step icon 114 in the current sub-interface. Thus, when two processes include the same step, the icon generating system 100 does not need to capture the scene graph again.

In step S360, the control module 150 controls the display 400 to display the scene graph in response to the manual operation, for showing the process scene more clearly.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An icon generating system applied to an electronic device capable of generating a step icon for representing a step of a manufacturing process, the electronic device comprising at least one hardware processor, the icon generating system comprising a plurality of modules executed by the at least one hardware processor, the modules comprising:
an instruction generating module for generating a description instruction in response to a user's operation;
a capturing module for capturing a scene graph of a step of the manufacturing process in response to the description instruction; and
an icon processing module for generating a step icon according to the scene graph, and adds a step attribute with the step icon for associating the step icon with the step.

2. The icon generating system of claim 1, wherein the electronic device further comprises a display for displaying a process interface for showing the manufacturing process, the icon generating system further comprises a control module for controlling the display to display the step icon in the process interface according to the step attribute of the step icon, for representing the corresponding step in the process interface.

3. The icon generating system of claim 2, wherein the icon processing module is further used for associating the step icon with the scene graph, the control module is further used for controlling the display to display the associated scene graph when the user clicks the step icon.

4. The icon generating system of claim 1, wherein the icon generating module is used for reducing the size of the scene graph for generating the step icon.

5. The icon generating system of claim 2, wherein the process interface further comprise an information frame for displaying detailed information of the step.

6. An icon generating method implemented by the icon generating system applied to an electronic device capable of generating a step icon for representing a step of a manufacturing process, the icon generating system comprises a plurality of modules, the electronic device comprises a processor, the processor executes the modules to perform operations of generating the step icon, the icon generating method comprising:
generating a description instruction in response to manual operation;
capturing a scene graph of a step of the manufacturing process in response to the description instruction; and
generating a step icon corresponding to the step according to the scene graph, and adding a step attribute with the step icon for associating the step icon with the step.

7. The icon generating method of claim 6, wherein the electronic device further comprises a display for displaying a process interface for showing the manufacturing process, the icon generating method further comprises:
controlling the display to display the step icon in the process interface according to the step attribute of the step icon, for representing the corresponding step in the process interface.

8. The icon generating method of claim 7, further comprises:
associating the step icon with the scene graph; and
controlling the display to display the associated scene graph when the user clicks the step icon.

9. The icon generating method of claim 6, wherein the step of generating a step icon corresponding to the step according to the scene graph comprises:
reducing the size of the scene graph for generating the step icon.

10. The icon generating method of claim 7, wherein the process interface further comprise an information frame for displaying detailed information of the step.

11. A non-transitory storage medium storing a plurality of modules, the plurality of modules comprising instructions executable by a processor of an electronic device to perform an icon generating method for generating a step icon for representing a step of a manufacturing process, the icon generating method comprising:
generating a description instruction in response to manual operation;
capturing a scene graph of a step of the manufacturing process in response to the description instruction;
generating a step icon according to the scene graph, and adding a step attribute with the step icon for associating the step icon with the step.

12. The non-transitory storage medium of claim 11, wherein the electronic device further comprising a display for showing a process interface for showing the manufacturing process, the icon generating method further comprises:
controlling the display to display the step icon in the process interface according to the step attribute of the step icon, for representing the corresponding step in the process interface.

13. The non-transitory storage medium of claim 12, further comprises:
associating the step icon with the scene graph; and
controlling the display to display the associated scene graph when the user clicks the step icon.

14. The non-transitory storage medium of claim 11, wherein the step of generating a step icon corresponding to the step according to the scene graph comprises:
reducing the size of the scene graph for generating the step icon.

15. The non-transitory storage medium of claim 11, wherein the process interface further comprise an information frame for displaying detailed information of the step.
